(19) United States
(12) Patent Application Publication
(10) Pub. No.: US 2016/0236190 A1
(43) Pub. Date: Aug. 18, 2016

(54) INTRODUCING A LIQUID INTO A DEPRESSION OF A SAMPLE HOLDING PLATE

(71) Applicants: Marcel Kanter, Nurnberg (DE); Marco Klühr, Munchen (DE); Oliver Patrick Welzel, Speichersdorf (DE)

(72) Inventors: Marcel Kanter, Nurnberg (DE); Marco Klühr, Munchen (DE); Oliver Patrick Welzel, Speichersdorf (DE)

(21) Appl. No.: 15/016,754

(22) Filed: Feb. 5, 2016

(30) Foreign Application Priority Data
Feb. 16, 2015 (DE) 102015202748.1

(51) Int. Cl. B01L 3/02; G01N 1/28

(52) U.S. Cl. CPC B01L 3/0293; G01N 1/28; B01L 3/021; B01L 2200/0642; B01L 2300/06; B01L 2200/0621

(57) ABSTRACT

A method is provided for introducing a liquid into a depression of a sample holding plate by way of a controllable dispensing apparatus. The process of the introduction of the liquid is divided into the introduction of a first liquid volume and the introduction of a second liquid volume. A dispensing apparatus is also provided for introducing a liquid into a depression of a sample holding plate. The dispensing apparatus includes a control device that controls an actuator such that a first liquid volume and a second liquid volume are discharged out of an opening of a dispensing head.

This application claims the benefit of DE 10 2015 202 748.1, filed on Feb. 16, 2015, which is hereby incorporated by reference in its entirety.

### TECHNICAL FIELD

The present embodiments relate to a method for introducing a liquid into a depression of a sample holding plate, hereinafter also referred to, without restriction of its general validity, as titer plate, by way of a controllable dispensing apparatus. The present embodiments also relate to a dispensing apparatus for introducing a liquid into a depression of a sample holding plate.

### BACKGROUND

In the biology and chemistry sectors, there are numerous applications in which liquids are introduced into the individual depressions, also referred to as wells, of a titer plate. In automated methods, in particular, use is made here of titer plates with a multiplicity of wells.

Here, for the filling of the wells, use may be made of manually operable pipettes or automatic pipetting installations. In automated systems, the time available for filling the wells is limited, or it is desirable to reduce the required time.

In automatic pipetting installations, for example, it is possible for this purpose for multiple pipettes to be used simultaneously in order to fill several of the wells simultaneously in one working act.

The speed with which each individual well may be filled is however nevertheless limited, because a high filling speed may result in an overspill of the liquid out of the well. This is illustrated by way of example in FIG. 8. FIG. 8 depicts, in four chronologically sequential illustrations, how a droplet T of a liquid F is dispensed out of a pipette P into a well W. Here, the left-hand, first illustration depicts how the droplet T exits the pipette P. The second illustration depicts the droplet T shortly before it impinges upon the base of the well W. In the third image, it may be seen how the liquid F rises up along the side walls of the well. If the speed of the liquid F upon exiting the pipette P was too high, the liquid F rises beyond the edge of the well W, as may be seen in the fourth, right-hand illustration, giving rise to undesired fouling or contamination (struck through in FIG. 8) of the surroundings of the well.

### SUMMARY AND DESCRIPTION

The scope of the present invention is defined solely by the appended claims and is not affected to any degree by the statements within this summary. The present embodiments may obviate one or more of the drawbacks or limitations in the related art.

It is therefore an object of the present embodiments to increase a pipetting speed for filling a well without the risk of fouling of the surroundings of the well.

The method for introducing a liquid into a depression of a sample holding plate by way of a controllable dispensing apparatus provides the discharging of a first liquid volume, which may for example be a droplet, of the liquid out of the dispensing apparatus into the depression at a first speed, and the discharging of a second liquid volume of the liquid out of the dispensing apparatus into the depression at a second speed. Here, the second speed is higher than the first speed. Here, the first speed and second speed refer in each case to the speed of the liquid at the outlet opening of the dispensing apparatus. The depression of the sample holding plate may also be referred to, for example, as well or reaction chamber. A sample holding plate refers to any plate-like structure having depressions for receiving a substance or a material. A sample holding plate may for example also be referred to as reagent plate, dilution plate, or the like.

The dispensing apparatus, which term also encompasses, for example, pipetting apparatuses, for introducing a liquid into a depression of a sample holding plate has a dispensing head with an opening, which dispensing head is designed to accommodate the liquid to be introduced. Furthermore, an actuator is provided, wherein the actuator is coupled to the dispensing head and designed to discharge or dispense the liquid out of the dispensing head or out of the opening of the dispensing head. Here, the actuator may be composed, for example, of a piston-type syringe with a suitable drive mechanism or the like. Furthermore, the actuator itself may be designed to provide the liquid, for example, out of a reservoir. Alternatively, the liquid may also be provided by a separate device. A dispensing head refers to any element that may be used to dispense the liquid. For example, the dispensing head may have a pipette tip, a steel needle, a glass capillary, or the like. Here, the dispensing head may for example be of cylindrical or tapered design. Other shapes are likewise possible.

Finally, a control device is provided, wherein the control device is designed to control the actuator such that the actuator discharges a first liquid volume of the liquid out of the opening into the depression at a first speed and discharges a second liquid volume of the liquid out of the opening into the depression at a second speed higher than the first speed.

If a liquid volume of the liquid is introduced into an empty depression, the maximum speed that may be used is limited by the geometrical characteristics of the depression and by the physical properties of the liquid, because otherwise an overspill of the liquid would occur as discussed above.

The concept on which the present embodiments are based is that of dividing the process of the introduction of the liquid into two sub-processes. Here, a first liquid volume of the liquid is introduced into the depression at the first speed.

The liquid volume thereupon serves as a damper for a second liquid volume, which is introduced into the depression after the first liquid volume and at a higher speed than the first liquid volume. The liquid that has already been introduced into the depression by way of the first liquid volume represents a certain amount of potential energy, and may absorb a part of the kinetic energy of, and decelerate, the liquid of the second liquid volume.

Consequently, the kinetic energy that the second liquid volume may have before an overspill of the liquid out of the depression occurs is greater than in the case of a non-decelerated liquid volume. The second liquid volume may therefore be introduced or injected into the depression at a considerably higher speed without an overspill of the liquid occurring.

The division of a single introduction process into two sub-processes therefore leads to a shortening of the time required for the overall process.

The maximum possible first speed is dependent on a multiplicity of factors. In one embodiment, the first speed may be determined such that the liquid introduced into the depression by the first liquid volume does not, when it impinges upon a wall of the depression, flow out of the depression. For this purpose, consideration may be given, for example, to variables such as a size of the first liquid volume, the amount and shape of the first liquid volume, a viscosity of the liquid, a depth of the depression, a geometry of the depression, a surface tension of the liquid, and the like. The same applies to the second speed of the second liquid volume, wherein, for the latter, the damping effect of the first liquid volume may likewise be taken into consideration.

The maximum possible speeds for the first liquid volume and the second liquid volume may be determined in a variety of ways. For example, the first speed and/or the second speed may be determined experimentally. For this purpose, in one embodiment, for a predefined liquid, introduction processes are recorded using a high-speed camera, and the images are, for example, examined and evaluated visually or in automated fashion, for example, by way of an image recognition system, and the speed is configured in iterative fashion until the maximum possible speeds for the first liquid volume and the second liquid volume are attained. This permits simple configuration of the first speed and of the second speed to the specific dispensing apparatus with the liquid that is actually used.

Alternatively, the first speed and/or the second speed may also be determined mathematically. For this purpose, use may be made of fluid dynamics equations, for example, in combination with flow analysis in accordance with the finite element method. This permits a theoretical calculation of the first speed and of the second speed in advance. Furthermore, in one embodiment, a combination of the two stated possibilities may be used. Accordingly, mathematically determined first and second speeds may be checked and optimized by experimentation.

For further fine adjustment of the introduction process, the method may include waiting for a predefined waiting time between the discharge of the first liquid volume and the discharge of the second liquid volume. This makes it possible to further optimize the introduction process and to configure to the respective depression and liquid. The waiting time may refer to the time between the active discharge of the first liquid volume and the active discharge of the second liquid volume. Here, the waiting time may denote the time during which, between the discharge of the first liquid volume and the discharge of the second liquid volume, the liquid flows out of the dispensing apparatus or out of the opening at a speed that lies below 20%, below 10%, or below 5%, of the first speed, or during which, between the discharge of the first liquid volume and the discharge of the second liquid volume, no liquid flows out of the dispensing apparatus or out of the opening.

In one embodiment, the predefined waiting time may in this case be determined at least in a manner dependent on a size of the first liquid volume and/or of the second liquid volume and/or on a viscosity of the liquid and/or on a surface tension of the liquid and/or on a depth of the depression and/or on a geometry of the depression.

Consequently, in one embodiment, the introduction process is divided into three sub-processes: the introduction of the first liquid volume, the waiting for the predefined waiting time, and the introduction of the second liquid volume. In this case, each individual one of said sub-processes may be configured in detail to the respective conditions. The overall duration of the introduction process may be optimized in this way.

If the liquid of the first liquid volume is still in motion in the depression, a situation may arise in which the liquid of the second liquid volume intensifies said movement, resulting in an overspill of the liquid out of the depression. Therefore, in one embodiment, the predefined waiting time may be determined such that the liquid introduced into the depression by the first liquid volume assumes a state of rest before the second liquid volume is discharged. A state of rest refers to virtually no movement occurring on the surface of the liquid.

Alternatively, in one embodiment, the predefined waiting time may be determined such that no separation of the liquid introduced into the depression by the first liquid volume from the liquid introduced into the depression by the second liquid volume occurs. Such a variant permits a fast introduction of the two liquid volumes in succession, with damping of the second liquid volume by the first liquid volume nevertheless being realized.

In the case of an impingement of a liquid volume on a surface, a liquid accumulation may occur in the middle of the liquid volume, wherein the liquid accumulation bounces back perpendicularly from the surface. This effect is utilized in an embodiment in which the predefined waiting time is determined such that the second liquid volume impinges on the liquid of the first liquid volume as the liquid rises out of the depression after an impingement of the first liquid volume on a wall of the depression. In this embodiment, the second liquid volume impinges on the liquid bouncing back from the wall of the depression at the instant at which the latter liquid is moving at a high speed, or has high kinetic energy, directed oppositely to the speed or kinetic energy respectively of the second liquid volume. In this way, the damping effect is maximized, and a higher second speed is made possible. The above-described damping may also be utilized, by way of a suitably designed dispensing apparatus, in the case of a first liquid volume that bounces back non-perpendicularly.

In one embodiment, the predefined waiting time may, like the first speed and/or the second speed, be determined experimentally, in particular, on the basis of high-speed images. Additionally or alternatively, the predefined waiting time may be calculated on the basis of fluid dynamics equations, in particular, by way of analysis in accordance with the finite element method.

For finer adjustment of the discharge of the first liquid volume and of the second liquid volume, it is possible for not only the first speed and/or the second speed but also in each case a maximum acceleration and/or a maximum variation of the acceleration, also referred to as jerk, and/or a smoothing factor to be predefined. The jerk and the smoothing factor may in this case be specified in particular for actuators based on an electric motor, in order, for example, to be able to take into consideration the breakaway torques in the electric motor.

Possible values of the first speed of the first liquid volume may be, for example, 0.5 m/s to 1 m/s, 0.3 m/s to 0.45 m/s, or 0.1 m/s to 0.15 m/s.

Possible values of the second speed of the second liquid volume may be, for example, 0.6 m/s to 1.5 m/s, 0.35 m/s to 0.6 m/s, or 0.2 m/s to 0.3 m/s.

The above embodiments and refinements may be combined with one another in any desired meaningful manner. Further possible embodiments, refinements, and implementations also encompass combinations, which have not been explicitly mentioned, of features described above or described below with regard to the exemplary embodiments. In particular, a person skilled in the art will in this case also add individual aspects as improvements or enhancements to the respective basic form of the present embodiments.

### BRIEF DESCRIPTION OF THE DRAWINGS

Here, in the various figures, the same components are denoted by identical reference designations. In the figures:

FIG. 1 depicts a flow diagram of an embodiment of the method.

FIG. 2 depicts a block circuit diagram of an embodiment of the dispensing apparatus.

FIG. 3 depicts a diagram illustrating the shortening of the introduction process.

FIG. 4 is an illustration of a dispensing apparatus according to one embodiment and a corresponding diagram of the profile with respect to time of the introduction process.

FIG. 5 is a further illustration of a dispensing apparatus according to an embodiment.

FIG. 6 depicts an example of a diagram of a profile with respect to time of the introduction process for a predefined depression geometry.

FIG. 7 depicts an example of a further diagram of a profile with respect to time of the introduction process for a further predefined depression geometry.

FIG. 8 depicts an example of a pipetting process as already described above.

### DETAILED DESCRIPTION

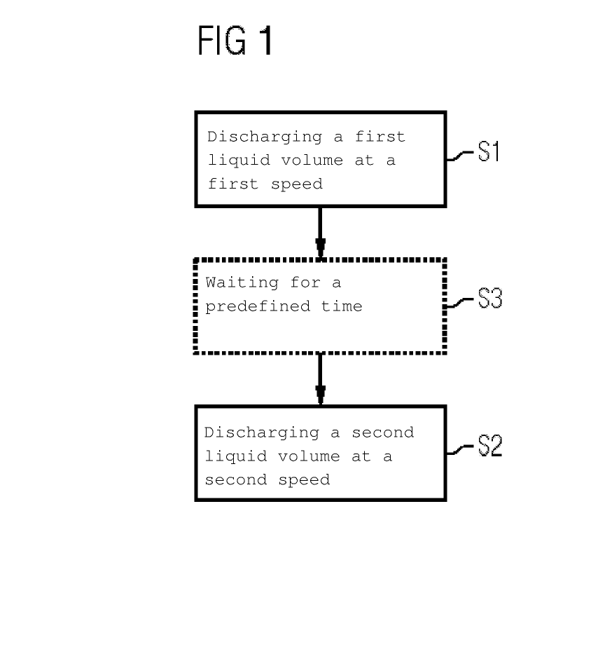

FIG. 1 depicts the discharge, S1, of the first liquid volume 5 and the discharge, S2, of the second liquid volume 6. The first liquid volume 5 is in this case discharged at a first speed 7 lower than the second speed 8 at which the second liquid volume 6 is discharged.

The waiting for a predefined waiting time 9, such as may be provided as an option in one embodiment, is illustrated by way of dashed lines.

The first speed 7 is selected such that, by the discharge, S1, of the first liquid volume 5, the liquid 1 is introduced into the depression 2 without spilling over the edge of the depression 2. Here, the first speed 7 may be configured for different geometries of the depression 2, different liquids 1, in particular, with different viscosities and surface tensions, and different amounts of the liquid 1 to be introduced, such that in each case the maximum possible first speed 7 is utilized.

The amount of liquid 1 introduced into the depression 2 through the first liquid volume 5 may in this case be selected so as to yield an optimum ratio of damping of the second liquid volume 6 and maximum first speed 7 for the first liquid volume 5.

Likewise, the second speed 8 is correspondingly set such that it assumes the maximum possible value for the introduction of the second liquid volume 6 without liquid 1 spilling over the edge of the depression 2.

For this purpose, the first speed 7 and the second speed 8 may, for example, be determined experimentally. For example, the introduction process may be recorded and analyzed using a high-speed camera. Here, the respective speed 7, 8 may, for example, be gradually reduced proceeding from a maximum possible speed 7, 8 of the dispensing apparatus 15. The reverse approach, in which the speed 7, 8 is gradually increased, is likewise possible.

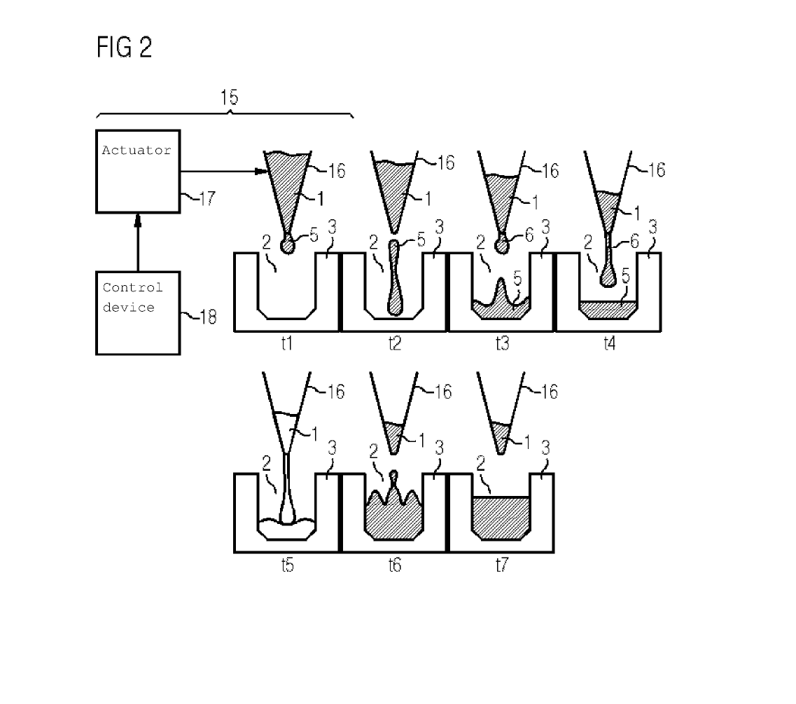

Alternatively or prior to the experimental determination of the first speed 7 and of the second speed 8, the geometry at least of the dispensing head 16 (see FIG. 2), of the dispensing apparatus 15 and of the depression 2 may be reproduced in an FEA simulation system, and the maximum possible speeds 7 and 8 determined by way of a flow simulation.

The course of the introduction process may exhibit different characteristics. For example, the second liquid volume 6 may be discharged when the liquid 1 of the first liquid volume 5 has approximately come to rest. This permits safer introduction of the second liquid volume 6 without the liquid 1 overflowing out of the depression 2.

Alternatively, the second liquid volume 6 may be discharged such that no separation between the liquid 1 of the first liquid volume 5 and the liquid 1 of the second liquid volume 6 occurs. This variant permits a fast discharge of the second liquid volume 6 after the first liquid volume 5, with a damping action of the first liquid volume 5 being maintained.

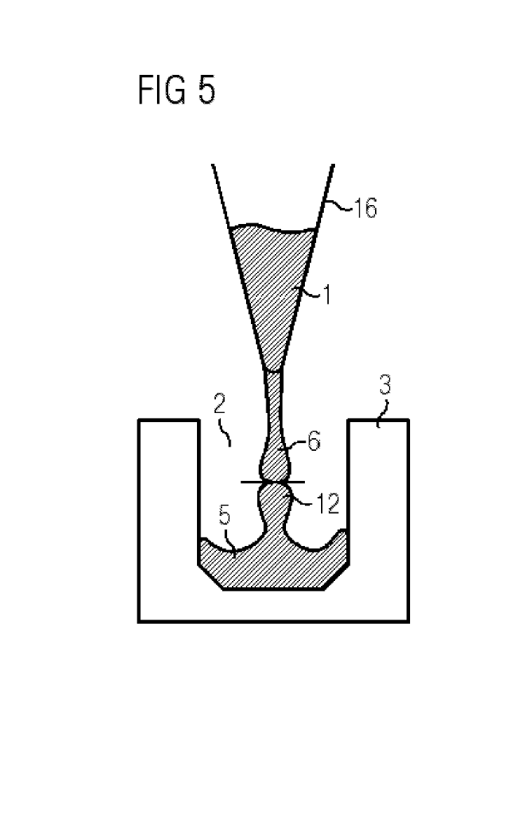

Since a part 12 of the liquid 1 of the first liquid volume 5, after impinging on the wall of the depression 2, at least partially splashes back perpendicularly to the wall surface (see FIG. 5), it is possible, in a further embodiment, for the second liquid volume 6 to be discharged exactly such that said second liquid volume impinges on the part 12 of the splashing-back liquid 1 of the first liquid volume 5 as said part is rising. In this way, the damping effect of the liquid 1 of the first liquid volume 5 is maximized.

The selection of the point in time for the discharge of the second liquid volume 6 may be performed in each case through suitable selection of a predefined waiting time 9 between the discharge of the first liquid volume 5 and the discharge of the second liquid volume 6. Here, the waiting time 9 may, like the first speed 7 or the second speed 8, be determined experimentally or mathematically, and in one embodiment, the waiting time denotes the time at which the liquid flows at a speed of below 20%, below 10%, or below 5% of the first speed, or the time during which no liquid flows out of the dispensing apparatus or out of the dispensing head.

For finer adjustment of the discharge of the first liquid volume 5 and of the second liquid volume 6, it is possible for not only the first speed 7 and/or the second speed 8 but also in each case a maximum acceleration and/or a maximum variation of the acceleration, also referred to as jerk, and/or a smoothing factor to be predefined.

Further influential variables for the calculation of said parameters may be, for example, the spacing between the dispensing head 16 and the titer plate 3, 3-1, 3-2, the diameter of the outlet of the dispensing head 16, the geometry of the depressions 2, 2-1, 2-2, and the liquid 1 itself, or the viscosity and surface tension of the liquid 1. In the case of an embodiment of the dispensing apparatus 15 having a piston-type syringe and a corresponding drive mechanism, the drive motor, the spindle power of a drive spindle, the transmission ratio of the drive spindle, or the like may also have an influence on the selection of the parameters. Alternatively, it is also possible for a pneumatic or hydraulic drive system to be provided in the dispensing apparatus 15.

FIG. 2 depicts an embodiment of the dispensing apparatus 15 at different points in time during the introduction process.

The dispensing apparatus 15 has a control device 18 that controls an actuator 17 that discharges liquid volumes 5, 6 out of the dispensing head 16 or out of the opening of the dispensing head 16. Here, the control device 18 controls the actuator 17 such that the liquid 1 is introduced into the depression 2 by way of two successively discharged liquid volumes 5 and 6.

To illustrate this process, FIG. 2 depicts the dispensing apparatus 15 at seven points in time t1-t7, starting from the first illustration at the top left to the final illustration at the bottom right. For clarity, the control device 18 and the actuator 17 are depicted only in the first illustration.

At the first point in time t1, the first liquid volume 5 forms at the dispensing head 16. At the second point in time t2, the first liquid volume 5 detaches from the dispensing head 16 and flows into the depression 2. In the third illustration at the third point in time t3, it may be seen that the first liquid volume 5 splashes back slightly in the depression 2, while the second liquid volume 6 is already forming at the dispensing head 16. At the fourth point in time t4, the second liquid volume 6 is already flowing downward from the dispensing head 16 in the direction of the liquid 1 of the first liquid volume 5, which in the interim has come to rest. The fifth illustration depicts how the second liquid volume 6, at the fifth point in time t5, impinges on the liquid 1 of the first liquid volume 5 and sets the latter in a slight oscillation, whereby damping of the movement of the second liquid volume 6 is realized. At the sixth point in time t6, the second liquid volume 6 has detached from the dispensing head 16 and the liquid sloshes up and down in the depression 2 without passing over the edge of the depression 2. At the time t7, the liquid 7 in the depression has come to rest.

In FIG. 2, the liquid 1 of the first liquid volume 5 dampens the fall of the second liquid volume 6. Consequently, the second liquid volume 6 may be discharged from the dispensing head 16 at a considerably higher second speed 8 than would be the case without the first liquid volume 5.

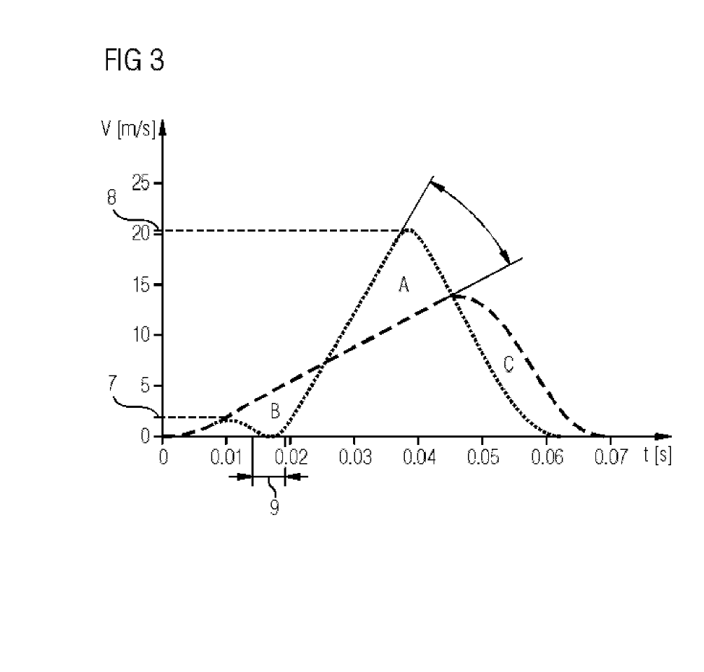

FIG. 3 depicts a diagram in which the speed of the liquid 1 is plotted versus the time. A first curve, illustrated by dashed lines, depicts the speed of the liquid 1 in the situation in which the entirety of the liquid 1 is introduced by way of only one liquid volume. Here, the speed rises approximately linearly from 0 m/s at 0 s to 13 m/s at 0.05 s, before then falling to 0 m/s at 0.07 s. Said first curve approximately forms a triangle with the abscissa.

By contrast, a second curve, illustrated by dotted lines, depicts the speed of the liquid 1 if it is introduced into the depression 2 by way of two liquid volumes 5, 6. It may be seen that the first speed 7 of the first liquid volume 5 reaches approximately 2 m/s at 0.01 s. Proceeding from approximately 0.02 s, the speed rises from 0 m/s to the second speed of approximately 20 m/s, before then falling to 0 m/s by 0.06 s.

The acceleration with which the liquid 1 of the liquid volume is accelerated in the case of the first line is in this case limited by the geometry of the depression 2 or the risk of fouling. By contrast, in an embodiment of the method, the acceleration limit is raised, and in the example illustrated, it is possible, for the second liquid volume 6, to utilize the maximum possible acceleration or final speed as limited by the mechanism.

Merely by way of example, the following maximum values for the discharge of the second liquid volume 6 are specified for an exemplary geometry of the depression 2 as shown depicted, for example, in FIG. 2: (1) Speed of the piston of the piston-type syringe: approx. 20 mm/s; (2) Speed of the second liquid volume 6: 20 m/s; (3) Acceleration of the piston of the piston-type syringe: 350 mm/s2; (4) Variation of the acceleration of the piston: 30 000-100 000 m/s; (5) Damping factor: 0.006-0.01 mm/s3.

The maximum first speed 7 of the first liquid volume 5 may in this case amount to approximately 2-3 m/s, wherein the acceleration is also lower than in the case of the second liquid volume 6.

The area for which the second curve has a higher value than the first curve is denoted by A. By contrast, the areas for which the first curve lies above the second curve are denoted by B and C. Here, the relationship A=B+C applies. Thus, the same amount of liquid 1 is discharged both times.

Furthermore, the waiting time 9 between the discharge of the first liquid volume 5 and the discharge of the second liquid volume 6 is denoted in the diagram.

It may be seen that the process of the introduction of the liquid is completed 0.01 seconds faster than the conventional process. In the case of a titer plate 3, 3-1, 3-2 with hundreds of depressions 2, it is thus possible for up to several seconds to be saved.

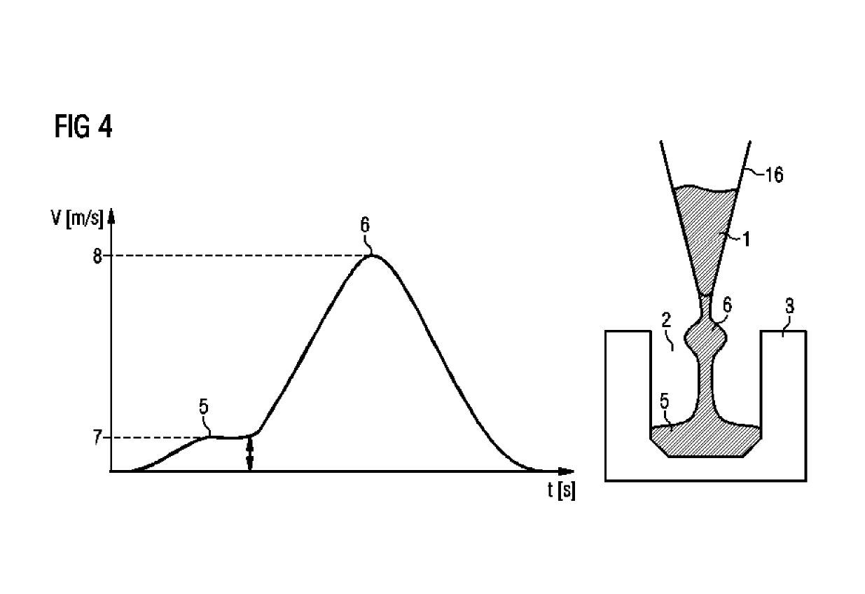

FIG. 4 illustrates an embodiment in which the second liquid volume 6 is discharged already when the first liquid volume 5 has not yet detached from the dispensing head 16. Thus, no separation between the first liquid volume 5 and the second liquid volume 6 takes place. In the speed/time diagram on the left adjacent to the illustration of the dispensing head 16, this may be seen in the fact that the speed does not return to 0 between the first speed 7 for the first liquid volume 5 and the second speed 8 for the second liquid volume 6. The axes of the diagram of FIG. 4 are not labeled with numerical values because these differ for different liquids 1 and different geometries of the dispensing head 16 and of the depression 2, and it is merely intended to illustrate the basic curve profile.

FIG. 5 depicts an embodiment in which the second liquid volume 6 is dispensed out of the dispensing head 16 exactly such that it impinges on splashing-back liquid 12 of the first liquid volume 5 while said liquid is rising. In this way, it is possible, as already discussed above, for the damping effect to be maximized, because the liquid 12 of the first liquid volume 5 and the liquid 1 of the second liquid volume 6 impinge on one another in opposite directions, and decelerate one another.

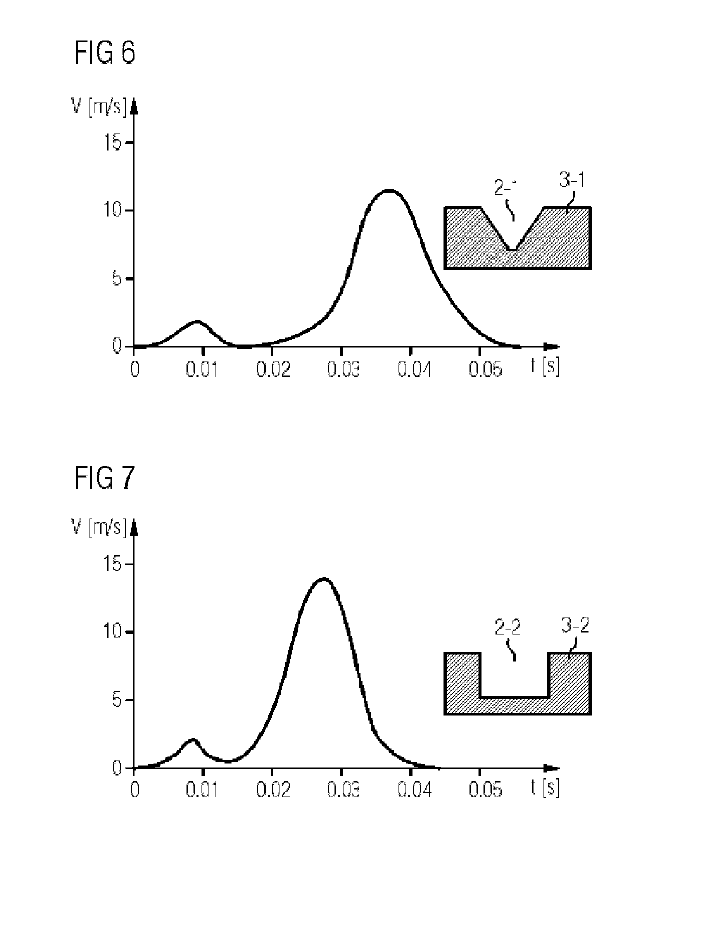

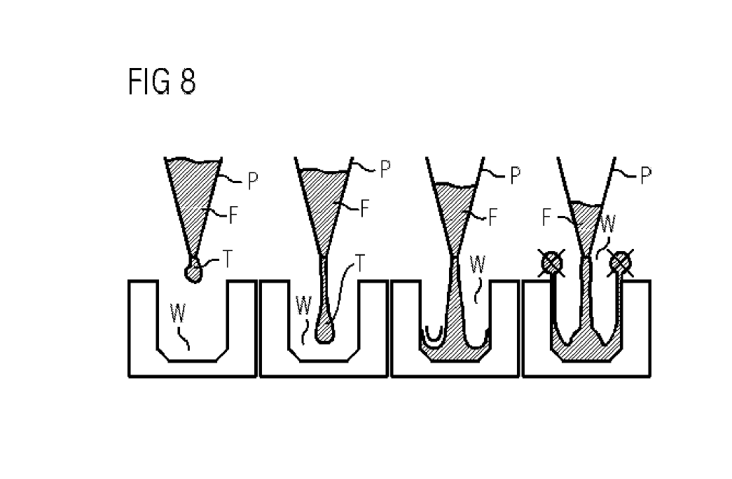

FIGS. 6 and 7 serve for illustrating different first and second speeds 7, 8 and different waiting times 9 in a manner dependent on the geometry of the depressions 2-1, 2-2 on the titer plates 3-1, 3-2.

The geometry of the depression 2-1 in FIG. 6 is funnel-shaped or of triangular cross section. The geometry of the depression 2-2 of FIG. 7 is, by contrast, quadratic.

Comparing FIG. 6 to FIG. 7, it may be seen that the first liquid volume 5 in FIG. 6 is discharged over a longer time period than the first liquid volume 5 of FIG. 7. Furthermore, the second liquid volume 6 of FIG. 6 is discharged considerably later and more slowly, at approximately 0.04 s and at approximately 12 m/s, whereas the second liquid volume 6 of FIG. 7 is discharged at already approximately 0.03 s and at approximately 15 m/s.

The funnel shape of the depression 2-1 of FIG. 6, with its oblique surfaces, promotes the splashback of the liquid 1. Therefore, the liquid 1 is introduced more slowly into the depression 2-1 of FIG. 6 than into the depression 2-2 of FIG. 7.

In FIGS. 6 and 7, it is clear that the introduction process is in each case individually set for different depressions 2, 2-1, 2-2 in order to prevent a splashback of the liquid 1.

Finally, it is pointed out once again that the methods and dispensing apparatuses described in detail above are merely exemplary embodiments that may be modified by a person skilled in the art in a wide variety of ways without departing from the scope of the invention. Furthermore, the use of the indefinite article “a” or “an” does not rule out a situation in which the features in question may also be provided multiply. It is likewise not ruled out that elements of the present invention that are presented as individual units may be composed of multiple interacting sub-components, which may possibly also be spatially distributed.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for introducing a liquid into a depression of a sample holding plate by way of a controllable dispensing apparatus, the method comprising:
discharging a first liquid volume of the liquid out of the dispensing apparatus into the depression at a first speed; and
discharging a second liquid volume of the liquid out of the dispensing apparatus into the depression at a second speed,
wherein the second speed is higher than the first speed.

2. The method of claim 1, wherein the first speed is determined such that the liquid introduced into the depression by the first liquid volume does not, when it impinges upon a wall of the depression, flow out of the depression.

3. The method of claim 2, wherein the first speed is determined based on a size of the first liquid volume, a viscosity of the liquid, a depth of the depression, a geometry of the depression, or a combination thereof.

4. The method of claim 1, wherein the second speed is determined such that the liquid introduced into the depression by the first liquid volume, the second liquid volume, or both the first or second liquid volumes does not flow out of the depression as a result of an impingement of the liquid introduced by the second liquid volume upon the liquid introduced by the first liquid volume.

5. The method of claim 4, wherein the second speed is determined based on a size of the second liquid volume, a viscosity of the liquid, a depth of the depression, a geometry of the depression, or a combination thereof.

6. The method of claim 1, wherein the first speed, the second speed, or both the first speed and the second speed are determined experimentally; and/or
wherein the first speed, the second speed, or both the first speed and the second speed are calculated based on fluid dynamics equations.

7. The method of claim 6, wherein the first speed, the second speed, or both the first speed and the second speed are determined experimentally based on high-speed images.

8. The method of claim 6, wherein the first speed, the second speed, or both the first speed and the second speed are calculated by way of analysis in accordance with the finite element method.

9. The method of claim 1, further comprising:
waiting for a predefined waiting time between the discharging of the first liquid volume and the discharging of the second liquid volume.

10. The method of claim 9, wherein the predefined waiting time is determined based on a size of the first liquid volume, a size of the second liquid volume, a viscosity of the liquid, a depth of the depression, a geometry of the depression, or a combination thereof.

11. The method of claim 9, wherein the predefined waiting time is determined such that the liquid introduced into the depression by the first liquid volume assumes a state of rest before the second liquid volume is discharged.

12. The method of claim 9, wherein the predefined waiting time is determined such that no separation of the liquid introduced into the depression by the first liquid volume from the liquid introduced into the depression by the second liquid volume occurs.

13. The method of claim 9, wherein the predefined waiting time is determined such that the second liquid volume impinges on the liquid of the first liquid volume as the liquid rises out of the depression after an impingement of the first liquid volume on a wall of the depression.

14. The method of claim 9, wherein the predefined waiting time is determined experimentally; and/or
wherein the predefined waiting time is calculated on the basis of fluid dynamics equations.

15. The method of claim 14, wherein the predefined waiting time is determined experimentally based on high-speed images.

16. The method of claim 14, wherein the predefined waiting time is calculated by way of analysis in accordance with the finite element method.

17. The method of claim 1, wherein one or more of a maximum acceleration, a maximum variation of the acceleration, or a smoothing factor is predefined for the discharge of the first liquid volume, the second liquid volume, or both the first liquid volume and the second liquid volume.

18. A dispensing apparatus for introducing a liquid into a depression of a sample holding plate, the dispensing apparatus comprising:
a dispensing head with an opening, wherein the dispensing head is designed to accommodate the liquid to be introduced;
an actuator coupled to the dispensing head and designed to discharge the liquid out of the opening of the dispensing head; and
a control device designed to control the actuator such that the actuator discharges a first liquid volume of the liquid out of the opening of the dispensing head into the depression at a first speed and discharges a second liquid volume of the liquid out of the opening of the dispensing head into the depression at a second speed, wherein the second speed is higher than the first speed.

19. The dispensing apparatus of claim 18, wherein the control device is designed to predefine one or more of the first speed, the second speed, or a waiting time between the discharge of the first liquid volume and the discharge of the second liquid volume such that no liquid flows out of the depression as a result of the introduction of the liquid.

20. The dispensing apparatus of claim 19, wherein the control device is designed to predefine one or more of the first speed, the second speed, or the waiting time based on a predefined size of the first liquid volume, a predefined size of the second liquid volume, a viscosity of the liquid, a depth of the depression, a geometry of the depression, or a combination thereof.

21. The dispensing apparatus of claim 19, wherein the control device is further designed to predefine a maximum acceleration, a maximum variation of the acceleration, a smoothing factor, or a combination thereof.
